(19) United States
(12) Patent Application Publication
(10) Pub. No.: US 2025/0003391 A1
(43) Pub. Date: Jan. 2, 2025

(54) TOWER-LIKE STRUCTURE FOR A WIND TURBINE, METHOD FOR MANUFACTURING SUCH A STRUCTURE, AND WIND TURBINE

(71) Applicant: ROSEN 2 Holding AG, Stans (CH)

(72) Inventor: Alexander Lindner, Ochtrup (DE)

(21) Appl. No.: 18/575,568

(22) PCT Filed: Jun. 29, 2022
(86) PCT No.: PCT/EP2022/067914

§ 371 Date: Aug. 28, 2024

(30) Foreign Application Priority Data
Jun. 29, 2021 (BE) BE2021/5506

(51) Int. Cl. F03D 13/20; E04H 12/34; F03D 13/25

(52) U.S. Cl. CPC F03D 13/205; E04H 12/342; F03D 13/25

(57) ABSTRACT

A tower-like structure is provided for a wind turbine. The tower-like structure includes at least one lower component and one upper component which is in part placed over the lower component to form a slip joint. The upper and the lower component each have a conical component section. The upper and the lower component also each have at least one further component section which jointly forms the slip joint and which, when viewed transversely with respect to a central longitudinal axis of the structure, is located above and/or below the conical component section. The surface perpendiculars of the further component sections intersect the longitudinal axis at an angle (a) greater than the surface perpendiculars of the conical component section.

### CROSS REFERENCE

This application claims priority to PCT Application No. PCT/EP2022/067914, filed Jun. 29, 2022, which itself claims priority to Belgian Patent Application No. BE2021/5506, filed Jun. 29, 2021, the entireties of both of which are hereby incorporated by reference.

### FIELD OF THE INVENTION

The present invention concerns a tower-like structure for a wind turbine, a method for manufacturing such a structure, and a wind turbine.

### BACKGROUND OF THE INVENTION

EP 3 443 224 B1 discloses generic objects. The tower-like structure or supporting structure for a wind turbine connects the nacelle carrying the rotor to the substrate, in particular the sea bed. In a generic structure, the connecting or overlap region of the slip joint is restricted to a respective conical region of the lower and upper components. Accordingly, the load is dissipated via the conical connecting region. This must be designed large according to the bending and support loads to be tolerated, which leads to costly structures.

### BRIEF SUMMARY OF THE INVENTION

It is an object of the present invention to improve the support structure provided for the expected loads such that the manufacture of the structure as a whole is more favorable.

This object is achieved by a structure in which the upper and the lower component each have at least one further component portion which co-forms the slip joint and which, when viewed transversely to a central longitudinal axis of the structure, is arranged above and/or below the conical component portion, and the surface perpendiculars of which intersect the longitudinal axis at a greater angle than the surface perpendiculars of the conical component portion. In the case of two further component portions of the upper and lower component, co-forming the slip joint, preferably one component is arranged above and the other below the respective conical component portion, and the surface perpendiculars of both the one and the other component portion intersect the central longitudinal axis of the structure at a greater angle than the surface perpendiculars of the conical component portion. The surface perpendiculars are here viewed in a vertical longitudinal section of the structure, i.e. at an identical circumferential angle relative to the central longitudinal axis of the structure which stands perpendicularly on a substrate when the structure is oriented vertically. The surface perpendiculars of the respective component portions run perpendicularly from the surfaces in the direction of the longitudinal center axis of the respective component, i.e. one surface perpendicular for example runs on an outside of the lower component, perpendicularly from its surface, through the wall of the component towards the longitudinal central axis. The surface of a conical component portion corresponds at least substantially, in particular completely to that of a truncated cone, disregarding production-induced tolerances or e.g. necessary beads of weld seams.

To form the slip joint with the at least one further component portion of the upper component, the at least one further component portion of the lower component lies at a height with respect to the longitudinal center axis. For the two further component portions per component, the two (second) further component portions also again lie at a height to one another. Preferably, the surface perpendiculars of this pair of component portions intersect the longitudinal axis-disregarding production-induced tolerances-at the same angle so that the component portions run in parallel.

In the prior art, load transitions occurring were calculated exclusively for the conical component portions to be dimensioned accordingly. The greater the overlap region, the lower the load or the greater the bending moments which can be absorbed. As structures become larger, the conical portions of the structure or supporting structure become ever larger and hence more costly. The invention uses the knowledge that the load transfers occurring can be at least partially separated or divided. For purely axial loads, for the same angles of the cone, a significantly shorter overlap length would suffice. According to the invention therefore, there is an at least partial separation of the axial forces which in particular are determined by the own weight of the upper component and wind turbine parts attached thereto, and the bending load caused for example by wind and waves. Whereas the axial force is still absorbed by the cone, the bending load is now at least partially co-absorbed by the additional component portion. The loads on the slip joint connection which result from the axial load and bending load then occur at different locations, and a stress superposition is at least partially avoided. The slip joint connection is thus formed by the regions of the components lying against one another and serving for load transmission, including any connecting elements arranged between the components.

This applies in particular to a variant of the invention in which, as well as the conical component portion, additional upper and lower component portions are present, and in which then the connecting region continues both upward and downward from a central conical region. In this case, the bending loads would be at least substantially dissipated, preferably to at least 80%, more preferably to at least 90% in these additional component portions.

Preferably, the surface perpendiculars of the further component portion of the upper and lower component are configured such that they intersect the longitudinal axis at a same angle. The course of the components in the in particular three-part connecting region is thus parallel, at least in the regions outside the transitions between the component portions. Both the lower and the upper component form three component portions forming the slip joint, wherein a respective one of the further component portions is formed above the conical component portion and the respective other of the two below the conical component portion.

Preferably, the angle at which the surface perpendiculars of the further component portion or portions intersect the central longitudinal axis differs from that of the conical component portion by at least 2°.

Preferably, the at least one further component portion of the lower and/or upper component is hollow cylindrical, and in particular formed by straight tube segments. The surface perpendiculars of the further component portion or portions then stand in particular perpendicularly to the central longitudinal axis. An in particular middle conical part (in the case of two further component portions) adjoining the at least one hollow cylindrical component portion may be designed significantly smaller and hence more cheaply. In particular as dimensions and loads become ever larger, because of the smaller dimensioning of the middle conical component portion, substantial cost advantages result for the manufacture of the structure according to the invention and a corresponding wind turbine.

In a variant of the invention which is particularly advantageous for load dissipation during operation, an upper and a lower component each have a conical component portion, wherein the further component portions are hollow cylindrical. The conical component portion is preferably adjoined upward and downward (relative to the central longitudinal axis in the operating position of the component) by a respective one of these further component portions.

Preferably, a connecting device, comprising a plurality of in particular annular, plate-like and/or layer-like and preferably elastic, in particular viscoelastic and/or compressible connecting elements, is arranged between the lower and upper components for the purpose of transmitting load between the upper and lower components. This connecting device may be arranged at least in one of the two or three portions of the connecting region of the slip joint which runs fully around a central longitudinal axis in the circumferential direction and thereby forms a sealing level. However, the connecting elements may also be arranged at a distance from one another, spaced apart from one another over the height of the structure along the central longitudinal axis and/or in the circumferential direction. In particular, no connecting element is arranged in the transitional regions between an e.g. hollow cylindrical tube or component portion and a conical component portion, which improves the arrangement of the respective connecting elements and increases the precision of fit. Preferably, at least with respect to the longitudinal direction, a plurality of connecting elements is arranged on each component portion, evenly distributed about the longitudinal axis in the circumferential direction.

In particular, in the conical middle component portion of the structure, the connecting device forms a circumferential seal. The arrangement of the seal in this region is particularly advantageous since any movements of the lower and upper components relative to one another in this component portion, resulting from the occurring bending loads, have only a negligible effect if the main bending loads are absorbed by a lower and an upper component portion.

In particular, the connecting elements are made at least largely from polyurethane. For example, these are polyurethane panels which have a coating of a slip lacquer or another friction-reducing coating on their surface to facilitate installation of the lower and upper components.

Depending on orientation of the component portions of the lower and upper component to be connected, the connecting elements which are arranged between connecting portions situated above one another with respect to the longitudinal axis have surface normals which are angled relative to one another. This again applies to observation of the vertical longitudinal section through the central longitudinal axis. Advantageously, the at least one connecting element arranged between the conical component portions has a different thickness than the adjacent connecting element, viewed in the direction transversely to the longitudinal axis. This takes account of the loads usually occurring there. Also, a connecting element may be provided with a thickness which varies in the direction of the superficial extent.

According to a further exemplary embodiment of a structure according to the invention, of the connecting elements which are arranged next to one another in the circumferential direction about the longitudinal axis, at least one has a greater thickness than a neighboring connecting element or one arranged above it with respect to the longitudinal axis. Thus tolerances occurring on one component can be compensated. For example, a connecting element may also have chamfered edges in order, during installation of the structure when the upper component is placed over the lower component, to allow the components to slide on one another more safely. This applies in particular for connecting elements arranged between upper and lower hollow cylindrical component portions.

Advantageously, at least some of the connecting elements are at least partially elastically, in particular viscoelastically, deformable. This may be utilized in targeted fashion for adapting the connecting elements to inaccuracies and unevennesses of the lower and upper components, e.g. in the form of weld seams, so that these can for example be securely embedded in a sealing level, or gaps formed by inaccurate arrangement of connecting elements can be closed. Also, the damping and hence the long-term stability of the structure may be increased. It may also help adaptation to the components if some of the connecting elements, at least therefore one connecting element, are provided with a varying thickness and thereby compensate e.g. for tolerances of a component or for weld seam elevations. The individual connecting elements may thus have a varying thickness in order to take account of any deviations on the component from a nominal dimension, for example in the form of weld seams. Similarly, the connecting elements may be provided with chamfers e.g. for the purpose of improved installation, or be at least partially wedge-shaped in cross-section.

The connecting elements of the connecting device are preferably at least largely, with the exception of any coatings or external glue layers, preferably made completely from a compact polyurethane which may be provided with openings. In the context of the invention, a compact polyurethane or a solid polyurethane means a solid body which is substantially free from gaseous inclusions. “Substantially free from gaseous inclusions” in this case means that the polyurethane contains gaseous inclusions to preferably less than 20 volume percent, particularly preferably less than 10 volume percent, in particular less than 5 volume percent, and quite particularly less than 2 volume percent.

In addition to the use of load-dissipating, at least partially elastic connecting elements, the thickness of which, viewed transversely to any superficial extent, may in particular lie between 2 and 10 cm, at least some of the connecting elements may be at least partially compressible, wherein the compressibility of the respective connecting element is formed in particular by a structuring of the surface, by openings in the material and/or by the material of at least one layer of the in particular multilayer connecting element. For example, this may be a foamed polyurethane connection which forms a plate-like connecting element.

Because of the compressible and/or at least partially elastic connecting element, as well as load transmission between the lower and upper components of the tower-like structure, also any forces occurring are damped, which improves the integrity of the structure in comparison with previously known connections using mortar or bolts.

The object cited initially is also achieved by a method for manufacturing a tower-like structure formed as described above and below, and wherein at least some of the connecting elements are molded and/or cast onto the lower and/or the upper component. Advantageously, the connecting elements are arranged on the transition piece independently of the production process. The application of a casting compound, e.g. in the form of polyurethane, may be improved by adhesion-promoting agents or primers, and the arrangement of plate-like connecting elements may be improved by adhesives.

In particular, one or more magnet holders are used which hold the connecting elements in position until they are securely fixed, e.g. by hardening of the adhesive.

Advantageously, at least some of the connecting elements are prefabricated and then attached to the lower and/or upper component. Preferably, all connecting elements are precast, e.g. in the form of plates, and then attached in particular to the upper component. One option, which is advantageous because easy to implement, for fixing the connecting elements lies in the use of a magnet holder, via which a connecting element can be held in the desired position on the upper or lower component at least until the connecting element is adequately secured.

The upper and/or lower component may be measured after manufacture to establish any deviations of the components from a predefined form due to production tolerances or e.g. weld seams, giving a deviation dimension arising from deviations from the nominal shape, which is then taken into account by a different thickness and/or superficial extent of the connecting elements. This can be taken into account during manufacture of the connecting elements. Preferably, the deviation dimension is however taken into account by after-machining of at least one of the connecting elements, which may take place e.g. by material removal by milling.

The object cited initially is also achieved by a wind turbine, in particular an offshore wind turbine, which has a structure as described above or below.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is an object according to the invention,

FIG. 2 is a cross-section through an object according to the invention.

FIG. 3 is detail views of the object according to the invention in FIG. 2.

FIG. 4 is a further object according to the invention.

FIG. 5 is a part view of the object according to the invention in FIG. 4.

FIG. 6 is aa (partial) vertical section through the object in FIG. 4.

FIGS. 7 to 11 are vertical longitudinal sections through further objects according to the invention.

### DETAILED DESCRIPTION OF THE DRAWINGS

Individual technical features of the exemplary embodiments described below, also in combination with the features of the claims, at least one of the independent claims, may lead to further refinements according to the invention. Where suitable, functionally equivalent parts carry identical reference signs.

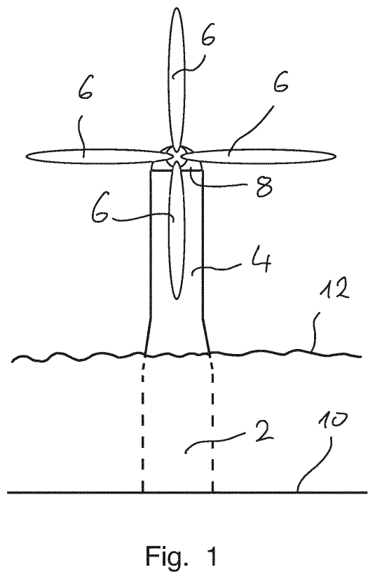

A wind turbine according to the invention is preferably configured as an offshore wind turbine with a lower component 2, over which an upper component 4 is placed. The lower component 2 is in this case (FIG. 1) configured as a monopile. The upper component 4, as a transition piece, ensures the transition to a nacelle 8 provided with rotor blades 6.

The wind turbine comprises a structure according to the invention, consisting of the lower and upper parts 2, 4 and any connecting device arranged in between. The lower component 4 is arranged standing vertically on the sea bed or substrate 10 and protrudes above the water surface 12. The loads acting on the connection between the lower and upper components arise firstly from the weight load of the transition piece, directed vertically down to the substrate 10, and the nacelle 8 arranged thereon. Wind and waves cause additional loads running horizontally to the substrate, which also act on the transition piece and hence must be dissipated via the connection to the monopile. Any vibrations or impacts acting on the monopile may be additionally transmitted in the direction of the transition piece.

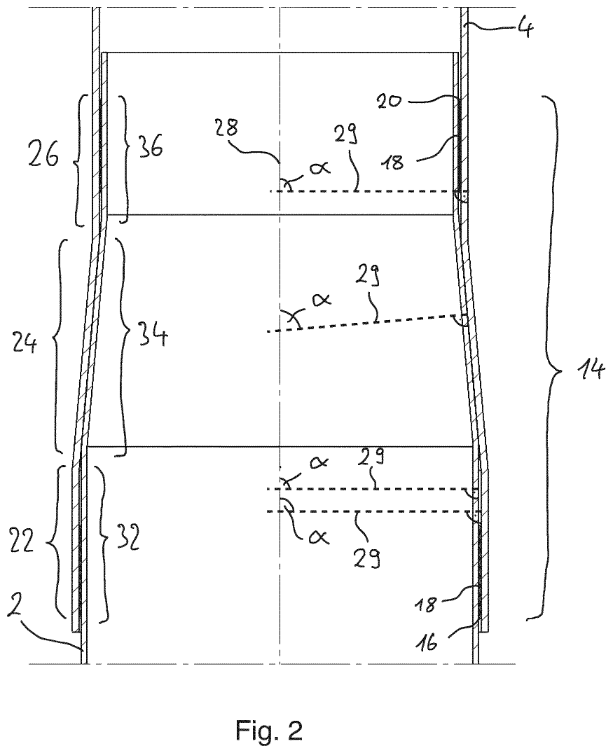

A design and connection according to the invention, in the manner of a slip joint for the structure or wind turbine according to FIG. 1, is disclosed in FIG. 2. A connecting region 14 extends from a lower end 16 of a connecting element 18 up to an upper end 20 of a further connecting element 18. In total, three component portions, by means of which the slip joint connection is formed, are provided for both the lower component 2 and also for the upper component 4. A first component portion 22 is defined by the lower hollow cylindrical part of the upper component 2 lying in the connecting region. This is situated below a conical component portion 24, also referred to below as the middle component portion of the transition piece. Above this is a component portion 26 which is again hollow cylindrical and has a smaller outer diameter than the lower component portion 22. The terms “lower”, “middle” and “upper” refer to the relative positions with respect to a central longitudinal axis 28 running vertically to the substrate 10 and centrally through the structure. Depending on allocation to the component portion, surface perpendiculars 29 to the outer surfaces of the lower component 2 and the inner surfaces of the upper component 4 intersect the central longitudinal axis, which runs in the middle of the structure viewed from above, at a different angle a, i.e. the upper and lower component portions 22 and 32 or 26 and 36, which generally adjoin the middle conical component portions 24 and 34, run at an angle to the latter. In the conical component portions 24 and 34, the surface perpendiculars 29 intersect the longitudinal axis 28 at an angle of around 85°, while in the upper and lower adjacent component portions, the surface perpendiculars stand perpendicularly, i.e. at an angle of 90° to the longitudinal axis.

The component portions of the lower component or monopile can be defined similarly to the component portions 22, 24 and 26 of the transition piece. A lower hollow cylindrical part 32 of the lower component 2 constitutes a lower component portion. This transforms upward into a middle conical component portion 32, which is formed by the conical region of the lower component 2 and at the top adjoins another hollow cylindrical component portion 36, the diameter of which both externally and internally is smaller than the diameter of the also hollow cylindrical component portion 32 situated further down. All component portions 22, 24, 26, 32, 34, 36 run circumferentially around the central longitudinal axis 28. In the drawings, for reasons of simplicity, arrows with curly brackets instead refer to component portions 22, 24, 26, 32, 34, 36.

In the exemplary embodiment of FIG. 2, the connecting elements 18 are arranged only between the cylindrical component portions 26 and 36, or 22 and 32, and serve to transmit the bending moments occurring. Since the vertical loads from weight are substantially constant and accordingly little damping is required, the conical component portions 24 and 34 lie on one another, so that there the load is transmitted directly between the conical elements. The bending loads occurring with significantly greater variance are transmitted substantially into the component portions 22, 32 and 26, 36, and partly through the oblique faces of the conical connecting portion. This results in particular from the lengths of the upper and lower component portions and their mutual spacing.

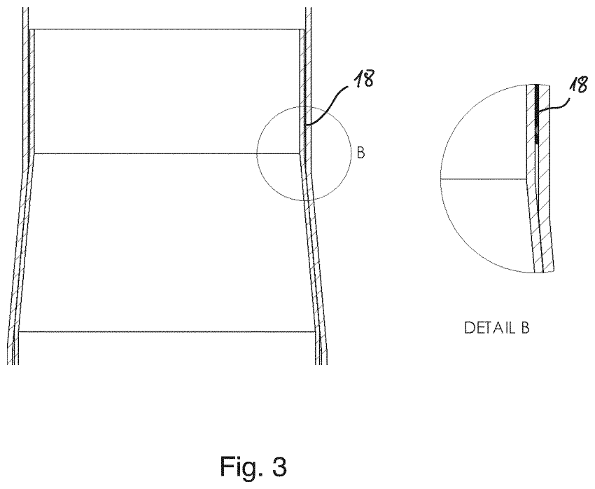

In the detail view of FIG. 3, it is evident that the connecting elements 18 from the respective upper component portions 26 and 36 do not extend into the conical region, which facilitates the formation and arrangement of the connecting elements.

The component portions of the lower and upper component together form three connecting portions of the connecting region 14. The first connecting portion comprises the lower component portions 22 and 32. The middle connecting portion is that with the conical component portions of the lower and upper components 2, 4. The third portion comprises the region of the upper hollow cylindrical component portions 26 and 36. Each of these connecting portions may comprise one or more parts of the connecting device.

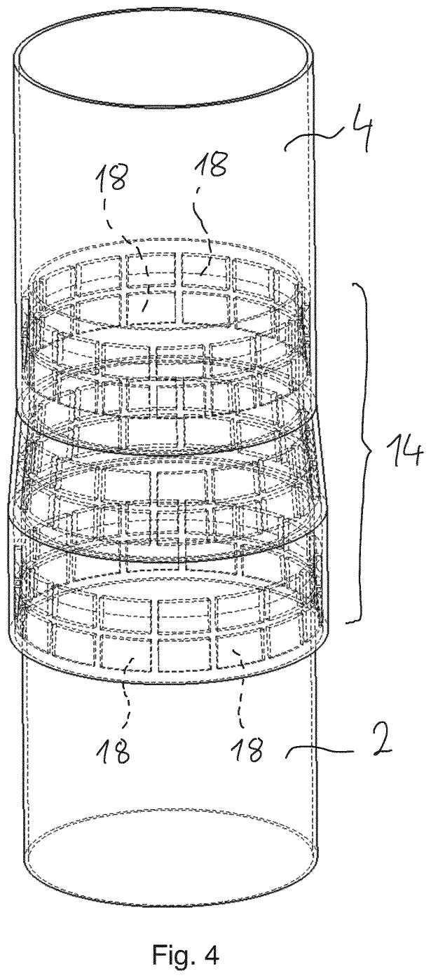

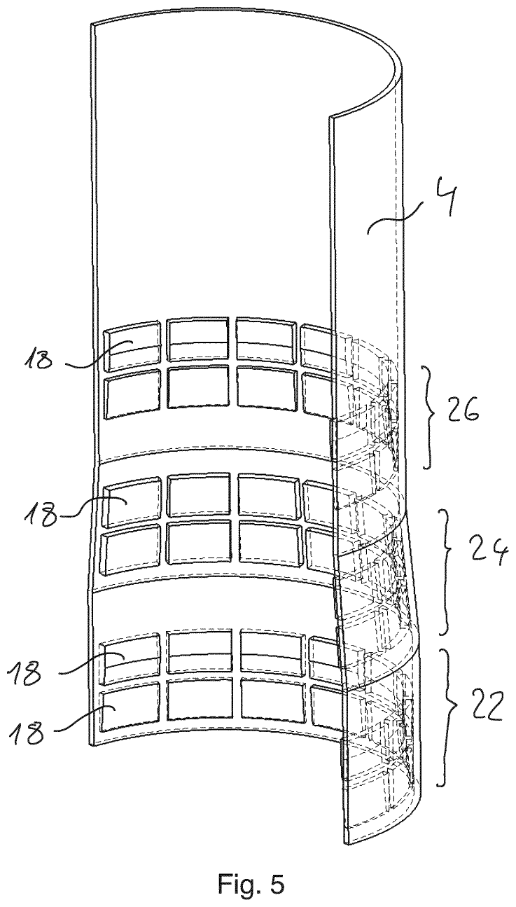

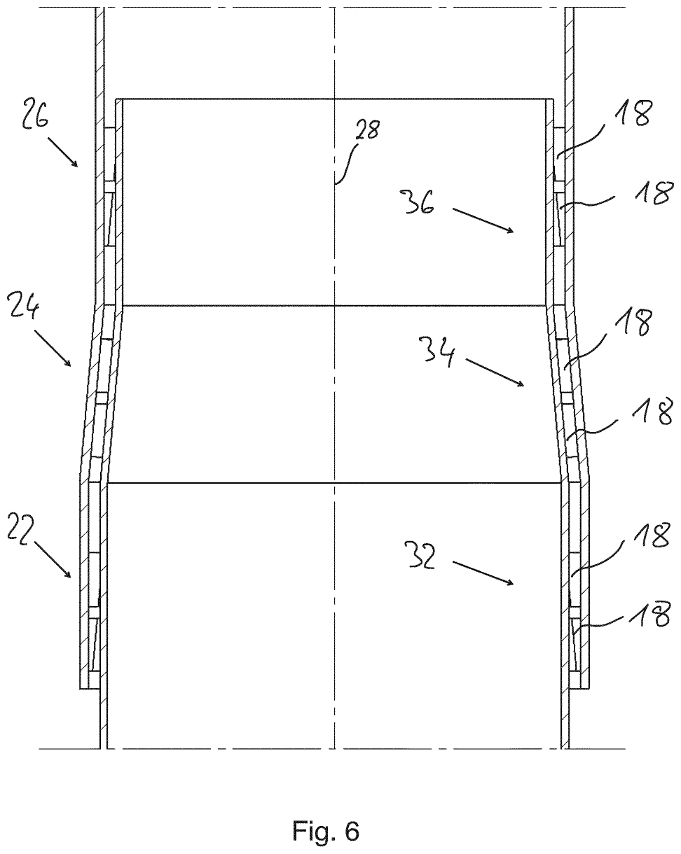

In the exemplary embodiment of FIG. 4, in each connecting portion, there are two rows of connecting elements 18, which are arranged next to one another in the circumferential direction and previously fixed to the transition piece spaced apart from one another. Whereas the connecting elements 18 situated in the conical connecting portion have a constant thickness, the connecting elements 18 arranged in the lower row of the hollow cylindrical component portion have a varying thickness in the direction of the longitudinal axis 18, which significantly simplifies the interconnection of the two components during mounting (FIG. 5 and FIG. 6). Similarly, the additional row, i.e. the second upper row of the hollow cylindrical component portions, is provided with connecting elements which at the lower end have a smaller thickness than at the upper end, in order to further improve assembly of the structure.

The thickness of the connecting elements 18 varies preferably at least over 30% of the thickness, further preferably over at least 80% of the thickness and up to 90% of the thickness, wherein when the connecting elements 18 are attached to the upper component 4, the end of the connecting elements 18 with narrower cross-section is at the bottom. If the connecting elements 18 are attached to the monopile or lower component 2 before the two components are interconnected, the narrower end of the connecting elements 18 is at the top.

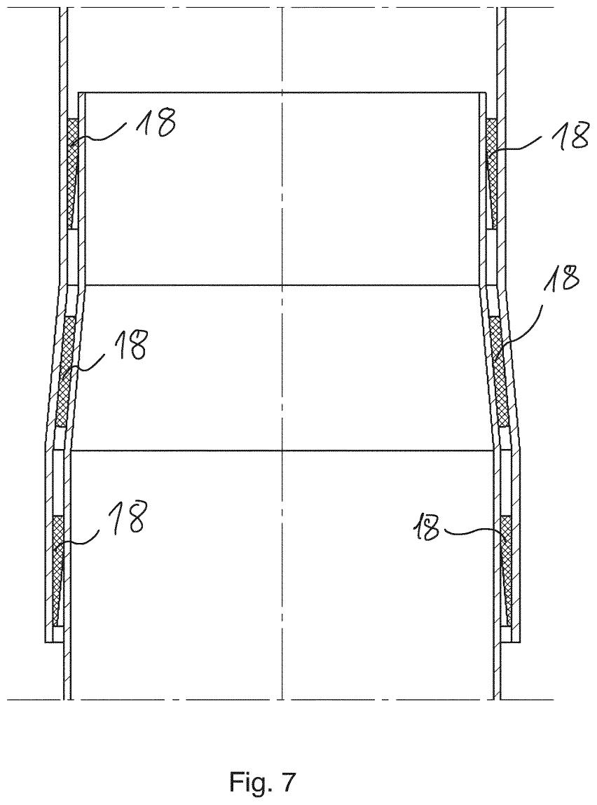

Instead of two rows of connecting elements 18, each connecting portion may have merely one connecting segment 18 wherein, as in the exemplary embodiment of FIG. 6, these connecting elements 18 which are arranged between the hollow cylindrical component portions again have a varying thickness (FIG. 7).

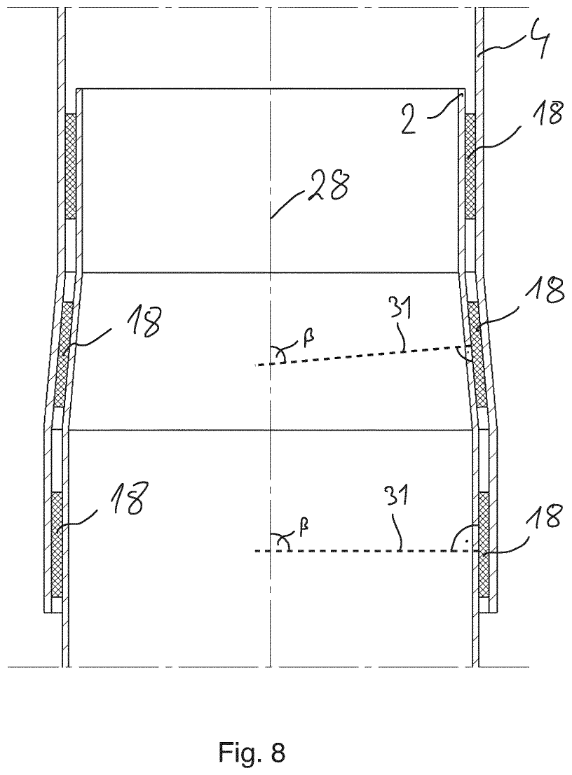

In the exemplary embodiment of FIG. 8, the thickness of the connecting elements 18 does not vary. Surface normals 31 of the connecting elements arranged one above the other intersect the central longitudinal axis 28 at different angles ß and are angled to one another accordingly. Now in all three connecting portions of the connecting region 14, these have an even thickness. The thickness is generally viewed transversely to the superficial extent of the connecting element. For measuring the thickness of the connecting elements, these are however regarded as not carrying load from the components of the structure. The thickness is in particular between 2 and 10cm and is preferably smaller by at least a of factor 5, more preferably by a factor of 10,than the width and/or length of the connecting elements 18. The thickness of a connecting element lying flat on a base is measured in the direction of a vertical to the substrate. For connecting elements arranged in the hollow cylindrical parts of the structure, the thickness is determined perpendicularly to the longitudinal axis. For connecting elements arranged in the conical connecting portion, the thickness of the connecting elements 18 is measured in the direction of a perpendicular to the surface of the lower or upper component. The superficial extent is then viewed perpendicularly to the direction in which the thickness is measured.

As an alternative to the plate-like connecting elements, the connecting device may also have rounded connecting elements. This may run circumferentially fully around the longitudinal axis and hence form a seal. Alternatively, they may also be provided solely for support purposes and for example be fixed on the transition piece in particular remotely and then placed over the monopile.

In general, the lower component need not be a monopile. It is also conceivable to configure a tower-like structure with a plurality of slip joint connections and for example as a tripod, so that the three legs of the wind turbine are each formed by means of a slip joint connection.

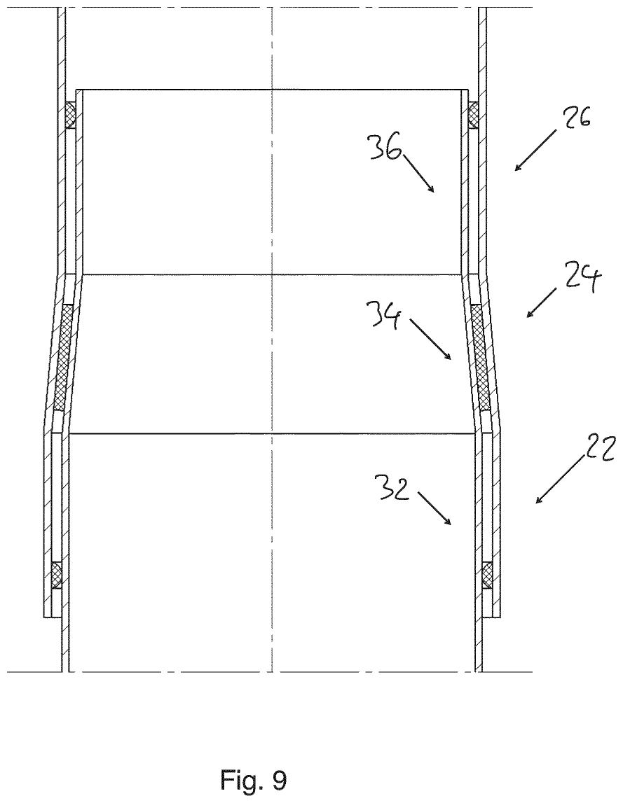

Preferably, the dimensions of the connecting elements 18 are dependent on the loads occurring in the regions concerned.

Whereas in FIG. 9, the connecting elements 18 arranged between the lower component portions 22 and 32, and between the upper component portions 36 and 26 have a comparatively small surface area in the vertical longitudinal section illustrated, the connecting elements 18 arranged in the conical connecting portion are formed significantly larger.

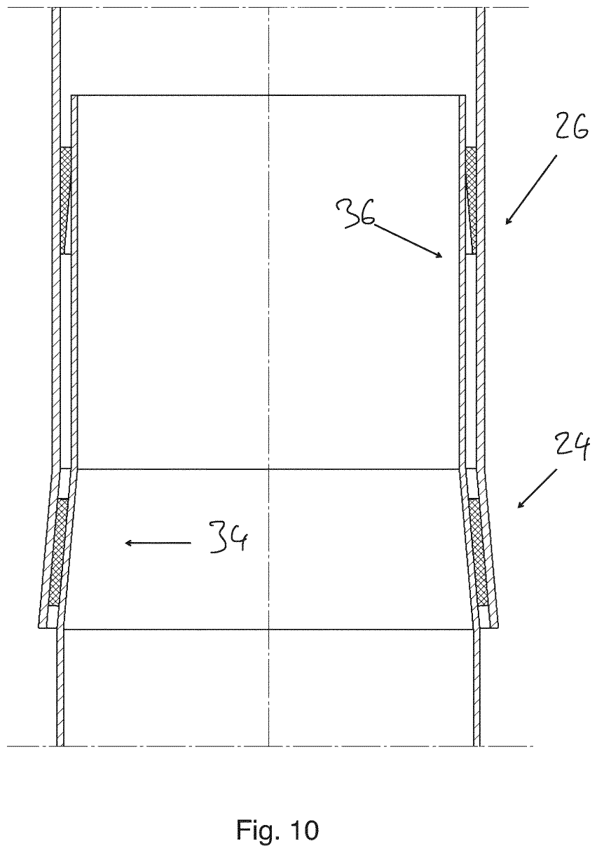

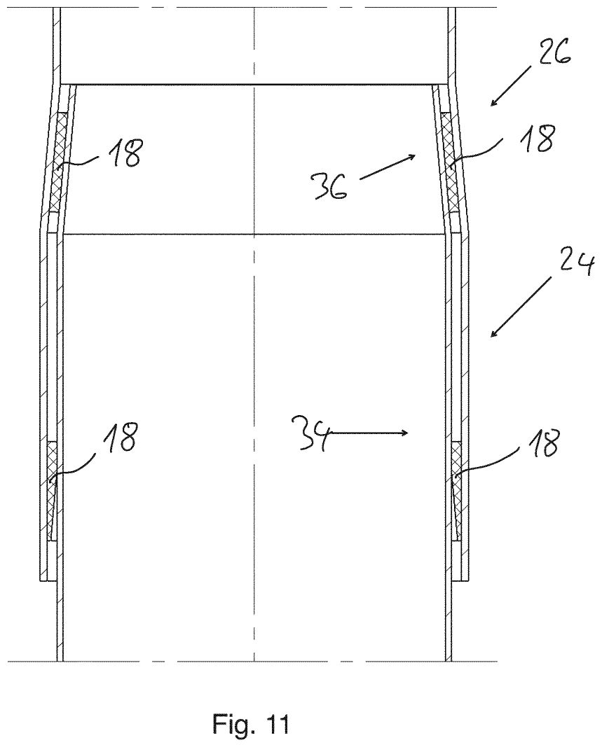

FIGS. 10 and 11 show further simplified embodiment variants of a tower-like structure in which only one hollow cylindrical component portion 26 or 36 extends upward (FIG. 10) or one hollow cylindrical connecting portion 22 or 32 extends downward from a respective conical component portion 22 or 24. Depending on the guidance, suitable during assembly, of either the lower component portion 22 of the upper component 4 (FIG. 11) or the component portion 26 of the upper component 4, the connecting elements arranged in the respective portions are then formed chamfered. Preferably, in general there is no chamfer of the connecting elements 18 in the conical region. However, independently thereof, in these regions the thicknesses of the connecting elements may be adapted to any deviations from the nominal dimension.

1. A tower-like structure for a wind turbine, the tower-like structure comprising:
at least one lower component, and
one upper component, which is partly placed over the lower component to form a slip joint,
wherein the upper and the lower component each have a conical component portion,
wherein the upper and the lower components each have at least one further component portion which co-forms the slip joint and which, when viewed transversely to a central longitudinal axis of the structure, is arranged above and/or below the conical component portion, and the surface perpendiculars of which intersect the longitudinal axis at a greater angle (α) than the surface perpendiculars of the conical component portion.

2. The structure as claimed in claim 1, wherein the surface perpendiculars of the further component portions of the upper and lower components intersect the longitudinal axis at a same angle (α).

3. The structure as claimed in claim 1, wherein the lower and upper components each have three component portions forming the slip joint, and a respective one of the two further component portions is formed above the conical component portion and the respective other of the two below the conical component portion.

4. The structure as claimed in claim 1, wherein the at least one further component portion of the lower and/or upper component is hollow cylindrical.

5. The structure as claimed in claim 4, wherein the lower and upper components each have two further component portions, wherein characterized in that the further component portions are hollow cylindrical.

6. The structure as claimed in claim 1, wherein a connecting device, comprising a plurality of, plate-like and/or layer-like connecting elements, is arranged between the lower and upper components to load between the upper and lower components.

7. The structure as claimed in claim 6, wherein the connecting elements which are arranged between connecting portions of the lower and upper components which are situated above one another with respect to the longitudinal axis have surface normals which are angled relative to one another.

8. The structure as claimed in claim 6, wherein of connecting elements which are arranged next to one another in the circumferential direction about the longitudinal axis, one has a greater thickness than the neighboring connecting elements.

9. The structure as claimed in claim 6, wherein at least some of the connecting elements are at least partially elastically deformable.

10. The structure as claimed in claim 6, wherein at least some of the connecting elements are at least partially compressible.

11. A method for manufacturing a tower-like structure as claimed claim 1, wherein at least some of the connecting elements are molded and/or cast onto the lower and/or the upper component.

12. A method for manufacturing a tower-like structure as claimed claim 1, wherein at least some of the connecting elements are prefabricated and then attached to the lower and/or upper component.

13. The method as claimed in claim 12, wherein the upper and/or the lower component is measured after production and any deviation dimension resulting from deviation from a nominal shape is compensated by different thickness and/or superficial extent of the connecting elements.

14. The method as claimed in claim 13, wherein the deviation dimension is compensated by after-machining of at least one of the connecting elements.

15. A wind turbine comprising the structure as claimed in claim 1.

16. The structure as claimed in claim 1, wherein the at least one lower component is a monopile, and the upper component is a transition piece.

17. The structure as claimed in claim 6, wherein the plurality of connecting elements are elastic and/or compressible.

18. The structure as claimed in claim 10, wherein the compressibility of the respective connecting clement is formed by a structuring of the surface and/or by the material of at least one layer of the connecting clement.

19. The method for manufacturing a tower-like structure as claimed claim 12, wherein at least one magnet holder is used for fixing the connecting elements.
